(19) United States
(12) Patent Application Publication
(10) Pub. No.: US 2003/0177214 A1
(43) Pub. Date: Sep. 18, 2003

(54) Dynamic SNMP network device

(75) Inventors: Yung-Hsin Chen, Hsinchu (TW); Ta-Shan Huang, Hsinchu (TW)

Correspondence Address: BACON & THOMAS, PLLC, 625 SLATERS LANE, FOURTH FLOOR, ALEXANDRIA, VA, 22314

(73) Assignee: D-Link Corporation, Hsinchu (TW)

(21) Appl. No.: 10/095,433

(22) Filed: Mar. 13, 2002

(51) Int. Cl. G06F 15/173

(52) U.S. Cl. 709/223

(57) ABSTRACT

The present invention relates to a dynamic SNMP network device comprising at least one MIB module and a dynamic SNMP agent engine installed therein. Each of the MIB module is generated corresponding to a certain MIB, contains necessary data variables and functions and provides the same behaviors as the corresponding MIB. The dynamic SNMP agent engine may load at least one MIB module depending on applications and, alternatively, unload any one of loaded MIB modules. Thus, the dynamic SNMP network device is capable of dynamically expanding or replacing a functional module for providing additional MIB capabilities.

### FIELD OF THE INVENTION

The present invention relates to networks and more particularly to a dynamic simple network management protocol (SNMP) network device with improved characteristics.

### BACKGROUND OF THE INVENTION

Over the past several years there has been an expansion of network. Also, various network devices have been developed and used in almost all trades and our daily life. This facilitates information communication and increases efficiency. As a result, our life is more comfortable and our work is more productive. However, more network management persons are bothered by how to effectively manage the various network devices.

With respect to many enterprises using local area networks (LANs) or the Internet as a tool for information communication therewithin, for enabling network management persons to effectively manage various network devices a SNMP agent is typically installed in a network device. Thus, network management stations (NMS) are capable of setting and managing SNMP based network devices. SNMP permits a network management person to access network from a remote computer and access a window about a SNMP network device so as to set, modify, and manage the same. But a network management person has to know an exact Internet protocol (IP) address of each network device prior to accessing the window about SNMP network device. Further, one SNMP network device is not allowed to have the same address as another one. Hence, a network management person has to know a predetermined IP address of each SNMP network device as well as be capable of setting and managing IP.

Conventionally, a kernel of SNMP agent (hereinafter called SNMP kernel) is bundled with behavior functions. In response to a loading of a management information base (MIB) file provided by a SNMP agent, NMS reads the MIB file so as to understand items supported by SNMP agent. Also, the NMS may access a remote file so as to achieve a desired network management.

However, the prior art suffered from a disadvantage. In detail, in the known SNMP network device, as stated above, a SNMP kernel is bundled with behavior functions. Hence, if it is desired to provide novel features with respect to newly developed and defined MIB by network device manufacturer by the known SNMP network device, the SNMP kernel should be altered. Otherwise, the desired purpose is not achievable. Therefore, for the SNMP network device manufacture, it is required to design a brand new SNMP agent if the known SNMP network device is commanded to support a newly developed MIB. In an embedded system, even the whole SNMP based network system should be designed again.

Thus, it is desirable to provide a SNMP network device capable of dynamically expanding or replacing an MIB module for loading a new MIB. Further, the SNMP network device is capable of preventing an updating of SNMP kernel from occurring while replacing the MIB module in order to overcome the above drawbacks of prior art.

### SUMMARY OF THE INVENTION

It is therefore an object of the present invention to provide a dynamic SNMP network device comprising at least one MIB module and a dynamic SNMP agent engine installed therein. Each of the MIB module is generated corresponding to a certain MIB. The MIB module contains necessary data variables and functions and provides the same behaviors provided by the corresponding MIB. The dynamic SNMP agent engine may load (or plug in) at least one MIB module depending on applications. Alternatively, the dynamic SNMP agent engine may unload any one of the loaded MIB modules. By utilizing the MIB modules, the dynamic SNMP network device is capable of dynamically expanding or replacing a functional module for providing additional MIB capabilities.

In one aspect of the present invention, the dynamic SNMP agent engine is applicable to all newly developed network devices, thus eliminating the need to develop a SNMP agent. It is only required to generate an MIB module associated with the network device based on new MIB prior to loading the same into the network device during the process of developing network device. As a result, a development time of network device is significantly reduced.

In another aspect of the present invention, only newly defined MIBs are required to provide to MIB module of the known network device in order to load MIB modules by the dynamic SNMP agent engine for dynamically expanding capabilities thereof.

In still another aspect of the present invention, for an embedded system the dynamic SNMP agent engine is permitted to bundle with SNMP kernel. Hence, it is possible of independently developing an MIB module for significantly reducing a development complexity.

The above and other objects, features and advantages of the present invention will become apparent from the following detailed description taken with the accompanying drawings.

### BRIEF DESCRIPTION OF THE DRAWINGS

FIG. 1 presents schematically a system structure and operation of a dynamic SNMP agent engine according to the invention;

FIG. 2 is detailed view of FIG. 1;

FIG. 3 is a flow chart illustrating a process performed by SNMP kernel associated with dynamic SNMP agent engine according to the invention;

FIG. 4 is a flow chart illustrating a process performed by MIB module dispatcher associated with dynamic SNMP agent engine according to the invention;

FIG. 5 is a flow chart illustrating a process performed by MIB module of dynamic SNMP network device according to the invention; and

FIG. 6 is a flow chart illustrating a process performed by MIB module loader associated with dynamic SNMP agent engine according to the invention.

### DETAILED DESCRIPTION OF THE PREFERRED EMBODIMENTS

The invention is directed to a dynamic SNMP network device comprising at least one MIB module and a dynamic SNMP agent engine installed therein. The MIB module is generated corresponding to a certain MIB. The MIB module contains necessary data variables and functions and provides the same behaviors provided by the corresponding MIB. The dynamic SNMP agent engine may load at least one MIB module depending on applications. Alternatively, the dynamic SNMP agent engine may unload any one of loaded MIB modules. By utilizing the MIB modules, the dynamic SNMP network device is capable of dynamically expanding or replacing a functional module for providing additional MIB capabilities.

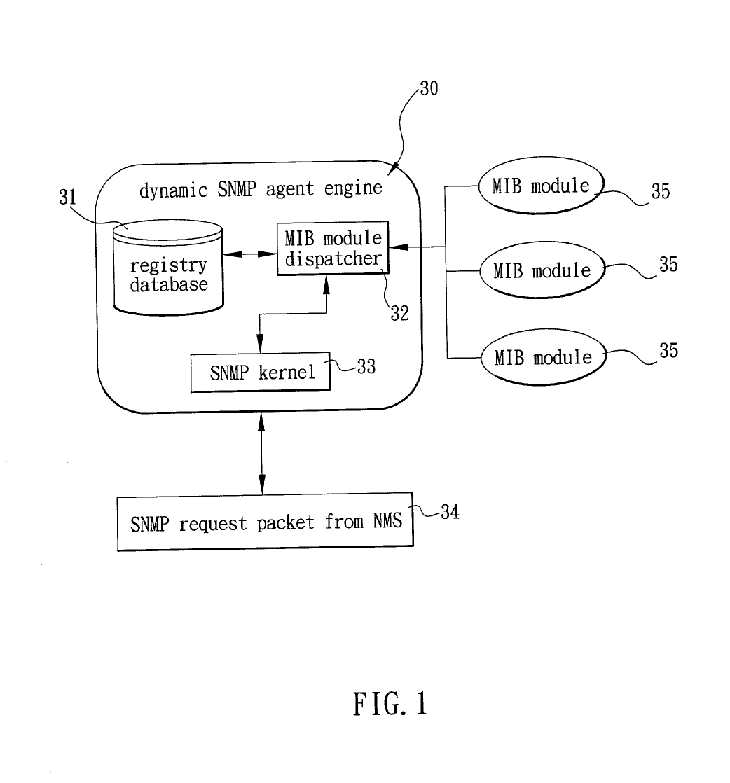

Referring to FIG. 1, there is schematically shown a preferred embodiment of a dynamic SNMP agent engine according to the invention. The dynamic SNMP agent engine 30 comprises a SNMP kernel 33, an MIB module dispatcher 32, and a registry database 31. The MIB module dispatcher 32 is coupled to the SNMP kernel 33, registry database 31, and at least one MIB module (three are shown) 35 respectively. The SNMP kernel 33 is further coupled to an NMS over the network. Thus, the SNMP kernel 33 can receive a SNMP request packet 34 from the NMS or alternatively transmit a SNMP response packet to the NMS. In the embodiment, such packet is a PDU packet. When the SNMP kernel 33 receives a SNMP request packet 34 over the network, the MIB module dispatcher 32 takes charge of the operation. Then MIB module dispatcher 32 analyzes the SNMP request packet 34 transmitted from SNMP kernel 33 prior to reading out an object identifier (OID) of the SNMP request packet 34. A character string of the OID is carried in a request packet conforming to the SNMP which is transmitted from the NMS. Also, the character string of OID must be an OID of MIB module or an entity OID of MIB table (i.e., belonging to the desired MIB module or MIB table).

After the MIB module dispatcher 32 has read the OID of the SNMP request packet, the MIB module dispatcher 32 searches a corresponding MIB module in registry database 31. A failure message is transmitted to the SNMP kernel 33 from the MIB module dispatcher 32 if a corresponding MIB module is not found. Next, the SNMP kernel 33 sends a response signal to a source address of the SNMP message. To the contrary, an invoke signal is transmitted to a corresponding MIB module 35 from the MIB module dispatcher 32 if a tree content of an MIB module is found to be matched with the OID. Next, the corresponding MIB module 35 may process the behaviors requested by the SNMP request packet. After the process, the corresponding MIB module 35 sends the result to the SNMP kernel 33 through the MIB module dispatcher 32. The result is capsulated in the packet by the SNMP kernel 33 prior to transmitting to the NMS which transmitted the SNMP request packet. This completes the operation. As regard the messages transmitted actively from the SNMP network device, such messages are either transmitted from the SNMP kernel 33 or the corresponding MIB module 35. In the former case, the messages are transmitted from the SNMP kernel 33 directly. While in the latter case, the message are first transmitted to the SNMP kernel 33 via the MIB module dispatcher 32 for processing prior to the transmission.

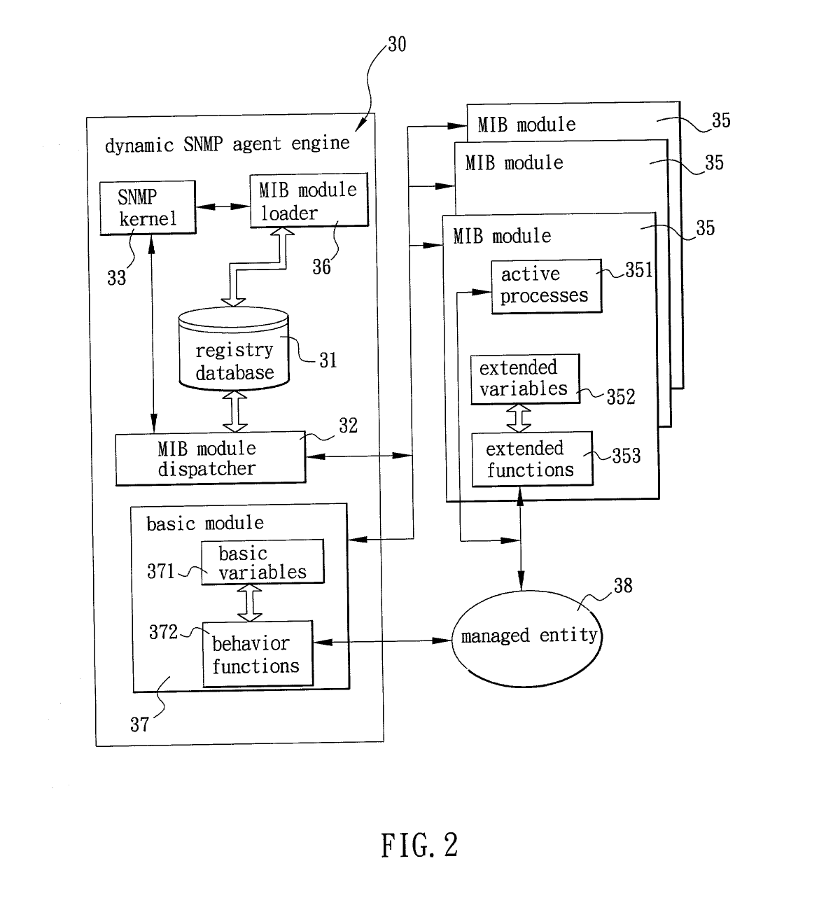

Referring to FIG. 2, there is shown another preferred embodiment of the dynamic SNMP system of FIG. 1. The system comprises a dynamic SNMP agent engine 30, at least one MIB module (three are shown) 35, and a managed entity 38. Dynamic SNMP agent engine 30 comprises a SNMP kernel 33, an MIB module dispatcher 32, a registry database 31, an MIB module loader 36, and a basic module 37. The MIB module dispatcher 32 is coupled to the SNMP kernel 33, registry database 31, at least one MIB module 35, and basic module 37 respectively. The SNMP kernel 33 is further coupled to an NMS over the network. The MIB module loader 36 is coupled to the registry database 31.

In the another preferred embodiment, the SNMP kernel 33 is a standard kernel associated with the SNMP agent. The SNMP kernel 33 can transmit or receive messages over the network and process the related SNMP messages. The SNMP kernel 33 comprises an interface for communicating with the MIB module dispatcher 32. The MIB module dispatcher 32 acts to receive SNMP packet transmitted from the SNMP kernel 33 and analyze the same. An OID is read out from the SNMP in response to the analysis. Then an MIB module corresponding to the OID is found in the registry database 31 based on the OID by searching. Thus, it is possible of knowing which MIB module 35 is in charge of processing a behavior requested by the SNMP request packet as well as transmitting an invoke signal to the corresponding MIB module 35. After data processed by the corresponding MIB module 35 has been received, data is transmitted to the SNMP kernel 33. Next, the SNMP kernel 33 performs a standard SNMP packet processing on the data prior to transmitting to a remote NMS. The registry database 31 is a set of corresponding tables which is implemented as a tree hierarchy for storing data. The registry database 31 comprises name of at least one MIB module and OID corresponding to the MIB module. The MIB module loader 36 acts to load or unload MIB modules. In a loading or unloading of each MIB module, the MIB module loader 36 has to update data registered in the registry database 31 simultaneously.

In the another preferred embodiment, the basic module 37 is a module being selectable during installation. The basic module 37 comprises general or network device related to basic variables 371 and behavior functions 372. The MIB module 35 is either a dynamic linking data file or an executable file. In a Microsoft system, the MIB module 35 is a file having an extension of either .DLL or .exe. In a Unix system, the MIB module 35 is an executable file having an extension of .so. In an embedded system, any one including active processes 351, extended variables 352, and extended functions 353 and having a dynamic linking structure can satisfy the requirement of the MIB module 35 according to the invention. Generally speaking, an active process means that a network device embeds an active message (e.g., SNMP trap) of a SNMP agent in a generated message and transmits the message to the SNMP kernel 33 through the MIB module dispatcher 32. Extended variables and extended functions are variables and functions required in generating an MIB module. Extended variables consist of a group of extended variables (with respect to basic variables) while extended functions consist of a group of extended behavior functions (with respect to basic behavior functions) respectively. Such extended variables and extended functions are in cooperation with the active process so that a generated MIB module is capable of performing behavior defined by MIB. As regard the managed entity 38, it is an entity (e.g., hardware, application programs, or operating system) managed by the dynamic SNMP agent engine. The managed entity 38 is coupled to the basic module 37 and each MIB module 35 respectively. Hence, the behavior of the basic module 37 or each MIB module 35 is implemented as a control and access to the managed entity 38.

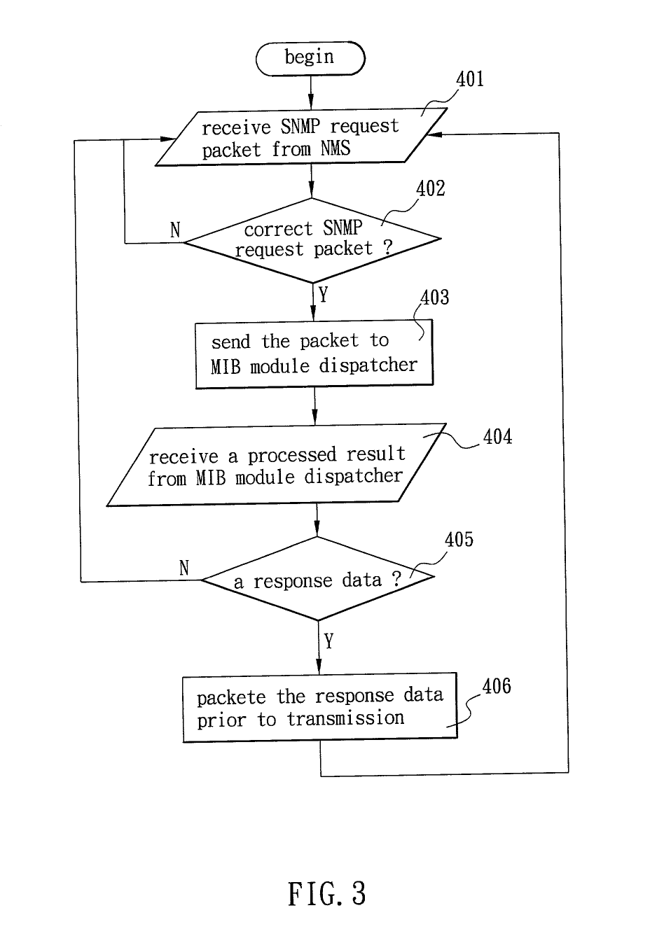

Referring to FIG. 3, there is shown a flow chart illustrating a process performed by the SNMP kernel 33 with respect to the SNMP message transmitted from the NMS or the MIB module dispatcher 32 according to the invention.

In step 401, receive a SNMP request packet from an NMS.

In step 402, determine whether the received packet is a correct SNMP request packet. If yes, the process goes to step 403. Otherwise, the process loops back to step 401.

In step 403, transmit the received packet to the MIB module dispatcher 32. Also, transfer a control of the SNMP request packet to the MIB module dispatcher 32.

In step 404, receive a processed result from the MIB module dispatcher 32.

In step 405, determine whether the received result is a response data. If yes, the process goes to step 406. Otherwise, the process loops back to step 401.

In step 406, capsulate the response data into a standard SNMP response packet prior to transmitting to the NMS.

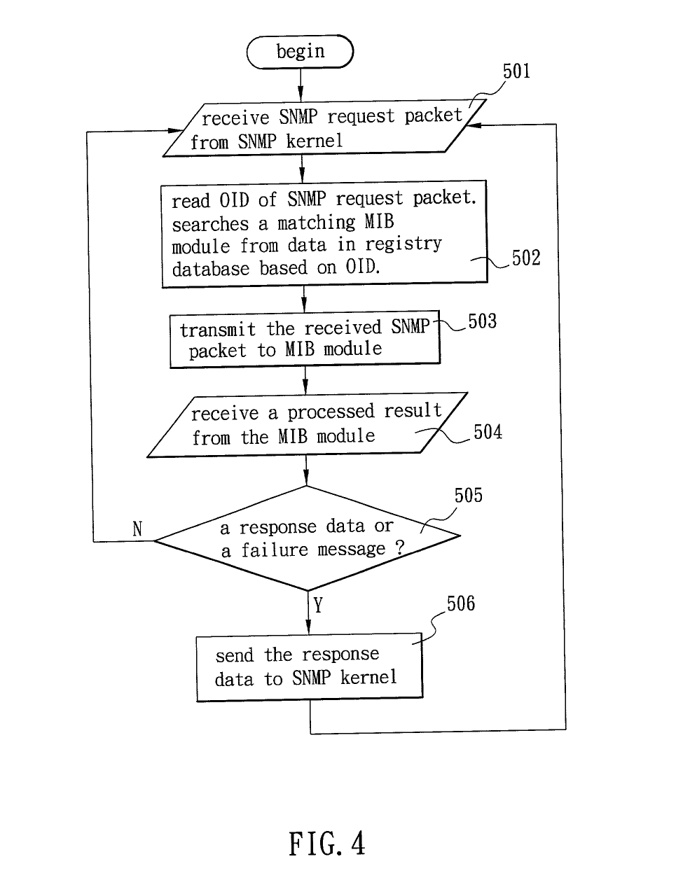

Referring to FIG. 4, there is shown a flow chart illustrating a process performed by the MIB module dispatcher 32 with respect to the message transmitted from the SNMP kernel 33 or the MIB module 35 according to the invention.

In step 501, receive a SNMP request packet transmitted from the SNMP kernel 33.

In step 502, read an OID of SNMP request packet. Then search a corresponding MIB module from data stored in the registry database 31 based on the OID.

In step 503, transmit the received SNMP request packet to a suitable one of MIB modules 35 corresponding to an MIB module parameter.

In step 504, receive a processed result from the suitable MIB module 35.

In step 505, determine whether the received result is either a response data or a failure message. If it is a response data, the process goes to step 506. Otherwise, the process loops back to step 501.

In step 506, send the response data to the SNMP kernel 33. Also, transfer a control of the SNMP request packet back to the SNMP kernel 33.

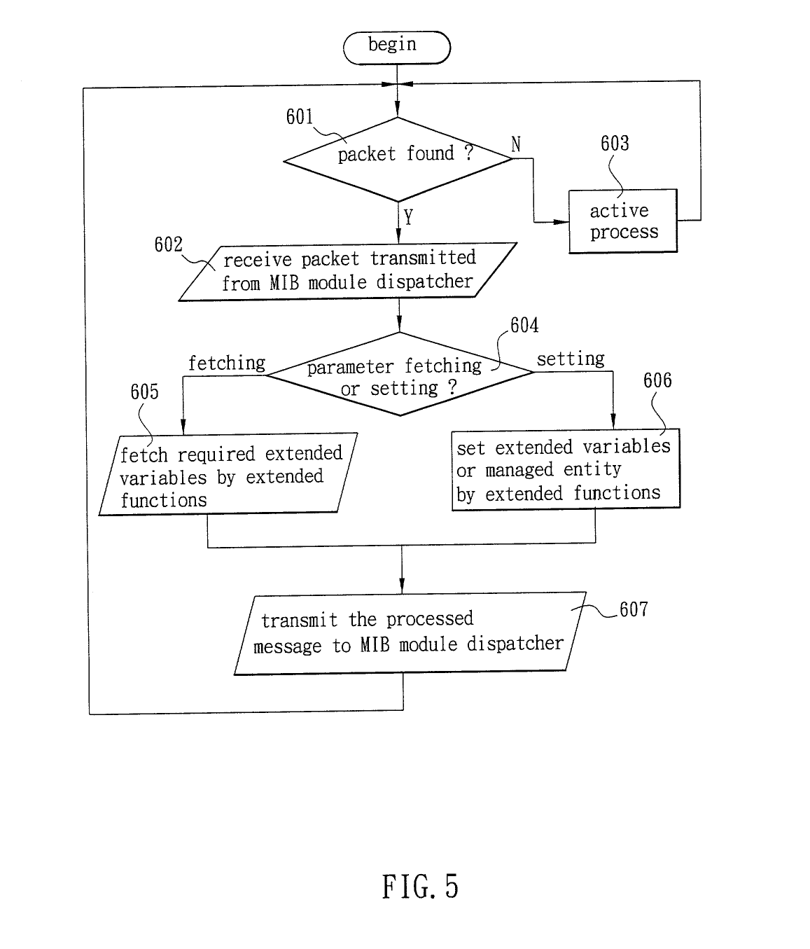

Referring to FIG. 5, there is shown a flow chart illustrating a process performed by the MIB module 35 with respect to message transmitted from the MIB module dispatcher 32 according to the invention.

In step 601, determine whether a packet transmitted from the MIB module dispatcher 32 is found. If yes, the process goes to step 602. Otherwise, the process goes to step 603.

In step 602, receive packet transmitted from the MIB module dispatcher 32. The process then jumps to step 604.

In step 603, an active process is performed. As such, an active message (e.g., SNMP trap) of a SNMP agent is embedded in a generated message. Further, transmit the message to the SNMP kernel 33 through the MIB module dispatcher 32. The process loops back to step 601.

In step 604, determine whether the received packet requests the MIB module 35 to perform a parameter fetching or setting with respect to the SNMP request packet. If it is a parameter fetching, the process goes to step 605. Otherwise (i.e., it is a parameter setting), the process jumps to step 606.

In step 605, fetch required extended variables by extended functions. The process jumps to step 607.

In step 606, set extended variables or managed entity by extended functions. The process jumps to step 607.

In step 607, transmit the processed message back to the MIB module dispatcher 32.

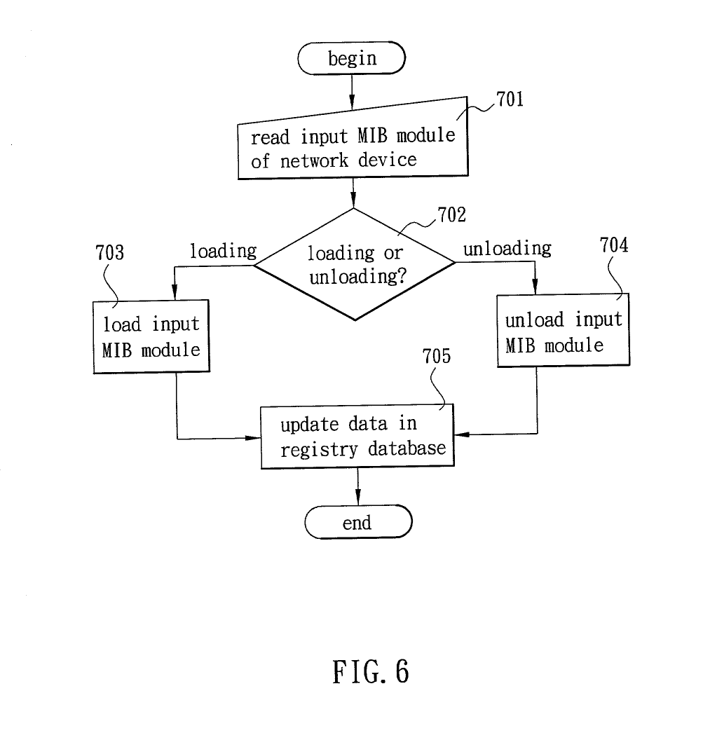

Referring to FIG. 6, there is shown a flow chart illustrating a process performed by the MIB module loader 36 with respect to a loading of MIB module into or unloading of MIB module from a network device according to the invention.

In step 701, read an MIB module of network device inputted by user through an input device.

In step 702, determine whether the input MIB module is about to load or unload. If it is a loading, the process goes to step 703. Otherwise (i.e., unloading), the process jumps to step 704.

In step 703, load the input MIB module into a network device. The process jumps to step 705.

In step 704, unload the input MIB module from the network device. The process jumps to step 705.

In step 705, update data registered in the registry database based on whether it is a loading or unloading process.

In brief, the dynamic SNMP network device of the invention can load at least one MIB module depending on applications. Thus, the dynamic SNMP network device is capable of dynamically expanding or replacing a functional module for providing additional MIB capabilities. Further, a dynamic SNMP agent engine is applicable to all newly developed network devices, thus eliminating the need to develop a SNMP agent. It is only required to generate an MIB module associated with the network device prior to loading the same into the network device by the dynamic SNMP agent engine during the process of developing network device. As a result, a development time of network device is significantly reduced. As to the known network device, a generation of required MIB module is made possible by referring to newly defined MIB prior to loading into the known network device.

While the invention has been described by means of specific embodiments, numerous modifications and variations could be made thereto by those skilled in the art without departing from the scope and spirit of the invention set forth in the claims.

What is claimed is:

1. A dynamic simple network management protocol (SNMP) network device comprising:
at least one management information base (MIB) module wherein each MIB module is generated corresponding to a predetermined MIB and each MIB module contains necessary data variables and functions and provides the same behaviors provided by the corresponding MIB; and
a dynamic SNMP agent engine for loading at least one MIB module depending on applications so that the dynamic SNMP network device is capable of dynamically expanding or replacing a functional module for providing additional MIB capabilities.

2. The network device of claim 1, wherein the dynamic SNMP agent engine comprises:
a SNMP kernel implemented as a standard kernel associated with a SNMP agent, the SNMP kernel being coupled to a remote network management station (NMS) over a network so as to receive a SNMP request packet from the NMS or transmit a SNMP response packet to the NMS, and process a standard SNMP message;
an MIB module dispatcher coupled to the SNMP kernel and at least one MIB module respectively, the MIB module dispatcher being operative to analyze the SNMP request packet transmitted from the SNMP kernel prior to reading out an object identifier (OID) of the SNMP request packet, or receive a processed message from at least one MIB module; and
a registry database coupled to the MIB module dispatcher for storing a name of each MIB module and the OID corresponding to each MIB module;
wherein when the SNMP kernel receives the SNMP request packet from the NMS over the network, the SNMP request packet is transmitted to the MIB module dispatcher for analysis so as to read out the OID of the SNMP request packet, in response the MIB module dispatcher searches a corresponding MIB module in the registry database based on the OID so as to know which MIB module is in charge of processing a behavior requested by the SNMP request packet and transmit an invoke signal to the corresponding MIB module, and in response to data processed by the corresponding MIB module has been received by the MIB module dispatcher, data is transmitted to the SNMP kernel for performing a standard SNMP packet processing thereon prior to transmitting to the NMS.

3. The network device of claim 1, wherein the SNMP request packet is a PDU packet.

4. The network device of claim 2, wherein the registry database is a set of corresponding tables implemented as a tree hierarchy for storing the name of each MIB module and the OID corresponding to each MIB module.

5. The network device of claim 2, wherein the dynamic SNMP agent engine further comprises:
an MIB module loader coupled to the registry database for loading or unloading the MIB module wherein in the loading or the unloading of each MIB module, the MIB module loader is commanded to update data registered in the registry database simultaneously.

6. The network device of claim 2, wherein the dynamic SNMP agent engine further comprises:
a basic module coupled to the MIB module dispatcher, the basic module being selectable during installation and including general or network device related to basic variables and behavior functions.

7. The network device of claim 2, further comprising a managed entity implemented as an entity of hardware, application programs, or operating system being managed by the dynamic SNMP agent engine, wherein the managed entity is coupled to the basic module and each MIB module respectively so that the basic module or each MIB module is operative to control and access to the managed entity.

8. The network device of claim 1, wherein the MIB module is either a dynamic linking data file or an executable file.

9. The network device of claim 1, wherein in a Microsoft system, the MIB module is a file having an extension of .DLL.

10. The network device of claim 1, wherein in a Microsoft system, the MIB module is a file having an extension of .exe.

11. The network device of claim 1, wherein in a Unix system, the MIB module is an executable file having an extension of .so.

12. The network device of claim 1, wherein in an embedded system, the MIB module has a dynamic linking structure and comprises active processes, extended variables, and extended functions.

13. The network device of claim 12, wherein each active process means that the network device embeds an active message of the SNMP agent in a generated message and transmits the message to the SNMP kernel through the MIB module dispatcher.

14. The network device of claim 12, wherein the extended variables and the extended functions are variables and functions required in generating each MIB module, the extended variables consist of a group of extended variables, the extended functions consist of a group of extended behavior functions, and the extended variables and the extended functions are in cooperation with the active process for enabling the generated MIB module to perform a behavior defined by the MIB.
